(19) United States
(12) Patent Application Publication
(10) Pub. No.: US 2026/0187273 A1
(43) Pub. Date: Jul. 2, 2026

(54) SYSTEMS AND METHODS FOR USER INPUT ROUTING

(71) Applicant: Wells Fargo Bank, N.A., San Francisco, CA (US)

(72) Inventors: Chao Chen, New York, NY (US); Thomas E. Bell, New Port Richey, FL (US)

(21) Appl. No.: 19/008,314

(22) Filed: Jan. 2, 2025

(51) Int. Cl. G06F 13/20

(52) U.S. Cl. CPC G06F 13/20; G06F 2213/40

(57) ABSTRACT

Systems, apparatuses, methods, and computer program products are disclosed for user input routing. In various examples, a topic of the user input and identifying sensitive data included in the user input may be determined. The sensitive data may be encrypted and an appropriate agent may be selected from at least one internal agent and at least one external agent. In various examples, an output may be generated in response to the user input.

### BACKGROUND

User inputs may include inquiries, instructions, and/or questions that may allow the user to perform an action, gain information relating to a question, etc. In some cases, the input may include technical questions, requests for information, requests for personalized recommendations, etc.

### BRIEF SUMMARY

User inputs including inquiries and related questions are an important source of information for users. For example, a user input may request specific information regarding a business's products and services and may include information about the user's situation, in an attempt to gain personalized responses. Traditionally, some user inputs may be received by an employee of a business, who may be trained to provide informational service to users. In some cases, the business may store user account information that may include information that may be related to the user inquiry, and which may be used to tailor the response to the particular user (e.g., by providing relevant product and service information).

Traditionally, user inputs have been handled by specially trained employees, trained to receive personal information relating to the user's situation and provide information and guidance on the potential products and services that may benefit the user. This requires hours of training for employees, to ensure a good informational service is provided to users. It may also require employees to be available for user inquiries outside regular business hours. In addition, the user may have to wait for the employee to find and/or understand user data maintained by the business, that may be pertinent in the user inquiry. The user input may include broad questions on topics relating to products and services that may change over time, in relation to institutional changes or the like. The employee may have to perform continuous research to actively maintain updated knowledge on a variety of topics relating to products and services. Additionally, the user input may include questions relating to other businesses products and services that the employee may have no information on or training to answer.

Traditional large language models (LLMs) may be used in generic manner to respond to user inputs. LLMs are trained on vast amount of data that may be leveraged to generate a response to a user input. Through the use of prompts large language models may be able to act as information sources for users in a variety of modalities. There are several types of large language models. Publicly accessible LLMs (e.g., GPT-4o, PaLM 2, Grok-1, Gemini, etc.), for example, may generate answers to user-input questions. Generally, publicly accessible LLMs may answer broad questions, but may struggle with specific directed questions relating to a specific institution's services, private information, or the like. Private LLMs, by contrast, may be trained on highly tailored datasets to be effective in answering a narrow set of inputs related to the specific field they are trained on. Due to the cost of training LLMs, private LLMs may be trained on smaller datasets relative to public LLMs. Private LLMs may provide additional security for handling user data. For example, private LLMs may be confined to a server system on a secure private intranet that does not have access to other external sources (e.g., the internet). As such, private LLMs may not be as well suited to answer broad questions relating to a user input. However, they may be more suited to answering direct and specific questions that may require specific institutional data. Previous systems utilizing LLMs have had to decide between using a private LLM or a publicly accessible LLM for the processing of user inputs. Publicly available LLMs may offer robust performance for a wide range of different user requests, potentially at the expense of security of user data and/or personalized responses. Private LLMs, by contrast, may provide enhanced security for handling user data and may offer more personalized responses, at the expense of providing responses to a larger number of general topics.

In contrast to these conventional techniques for responding to a user input, example embodiments described herein may improve conventional techniques by implementing large language models for the assessment of user inputs. The input routing system uses LLMs to classify and route user inputs to improve the output in response to a user input. The input routing system may receive a user input and generate a set of tasks. The LLMs may also produce a series of structured prompts designed to produce the best response to accomplish a task in the set of tasks, when provided to internal and/or external agents. The input routing system may determine if sensitive data (e.g., personally identifiable information (PII)) included in the user input is required to provide a response. If PII is not required, the system may mask the information to provide security to the user. The input routing system may also determine the agent or set of agents that may provide the best response to the user input, by determining a topic of the user input and generated tasks. This may include sending the structured prompts to an externally hosted agent, which may have access to more general information and/or to an internally hosted agent that may have access to user account data, entity-specific data (e.g., enterprise data such as information related to the entity's services, etc.), etc. In various embodiments, the prompts from the structured prompts may be sent to a combination of internal and external agents and their specific informational outputs may be combined by the user inquiry routing system. The internal agents may be private LLMs that have been trained on an entity-curated training dataset to perform well for common entity-specific tasks. The internal agents may be hosted on a secure intranet within the entity to ensure security of sensitive data. The external agents may be publicly accessible LLMs that have been trained on a vast amount of training data to provide a broad set of information. The external agents may be hosted on the internet and may be less secure and/or may not have access to sensitive data (e.g., user data). The combined output may be provided to the user in response to their input. The user input routing system may also be implemented on the premises of the entity and, as such, the combined output may be provided to an employee, who received the inquiry, to be relayed back to the user in response to their inquiry.

Accordingly, the present disclosure sets forth systems, methods, and apparatuses that use language models for the routing of user inputs. There are many advantages of these, and other embodiments described herein. For instance, the input routing system may determine the best source of information (e.g., internal agent and/or external agent) to respond to the user input, based on the content of the user input and the required information to produce a response. The selection of agents may improve the processing of the response. For example, by selecting the most appropriate source of information the input routing system may reduce the unnecessary processing of user input by large publicly accessible LLMs. The selection of the most appropriate source may reduce the processing time of the user input, leading to a faster responses and lower processing costs. In addition, the input routing system may determine if sensitive data is required to respond to the user input. In an instance where the sensitive data is not required to respond to the user input, the sensitive user data may be encrypted (e.g., hashed, masked, encoded, redacted, etc.) to avoid the sensitive information being divulged to third parties and/or to mitigate security risks to the user. In addition, the input routing system may decompose the user input into a series of tasks and/or prompts that may be sent to internal and/or external agents for processing. The user routing system may determine that sensitive data included in the first prompt is required to process the user input. Accordingly, the first prompt may be routed to an internal agent. The second prompt may include no sensitive data and/or may include sensitive data that is not required to process the user input and which may be encrypted. The second prompt may also relate to a broad topic without the need for institutional specific information. The second prompt may be routed to an external agent for processing. The user input routing system may receive the outputs from the two agents and combine them into a structured output relating to the user input. Additionally, the user input routing system may determine if additional user data and/or information is required to respond to a user input. The user routing system may allow for internal processing agents to access institutional data stored on a secure database. The institutional data may be user account specific and provide the necessary information for the user input routing system to produce a response to the user input. Finally, with all applicable permissions and appropriate user consent, the routing system may take user input from, for example, a user conversation with an employee onsite. The conversation may encompass a wide range of topics. The routing system may, in the background, retrieve the user input, generate various tasks and prompts, send these prompts to the selected agents, and combine their outputs. When the user is finished talking, the employee may already have the generated combined output relating to the topics that the user was discussing. The combined output may be sent to the user (with user permission) via email, or the output may be relayed by the employee to the user.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 is a block diagram illustrating an example user input routing system that may be used in accordance with various aspects of the present disclosure.

FIG. 2 illustrates a schematic block diagram of example circuitry embodying a system device that may perform various operations in accordance with some example embodiments described herein.

FIG. 3 illustrates an example flowchart for user input routing, in accordance with some example embodiments described herein.

FIG. 4 illustrates an example flowchart for the implementation of the logic agent, in accordance with some example embodiments described herein.

FIG. 5 illustrates an example flowchart for the implementation of the sensitivity agent, in accordance with some example embodiments described herein.

FIG. 6 illustrates an example flowchart for the implementation of the routing component, in accordance with some example embodiments described herein.

FIG. 7 illustrates an example flowchart for the implementation of the internal agent, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “artificial intelligence model” refers to a computational framework designed to process large amounts of data and based on the data processed generate structured analytical solutions to presented inquiries. Such models process data to recognize patterns, make decisions, and/or predict outcomes, often using techniques like machine learning (including, for example, artificial neural networks, transformer models, regression models, etc.).

The term “large language model” or “LLM” refers to a specialized artificial intelligence model that has been trained on text data to understand natural language input and generate responsive output (e.g., include natural language, multi-modal content, computer-executable instructions (and/or resulting computer-executed actions), and/or the like as described herein). Large language models may be implemented on a variety of computing devices, including but not limited to, computers, mobile devices, and servers. Large language models are probabilistic models of natural language. Large language models may be implemented for a variety of tasks, including, machine translation, natural language processing and/or the like. As described in more detail below, large language models may be used for natural language processing, for example the classification of language inputs. Large language models may learn statistical relationships from vast text training datasets via self-supervised or semi-supervised training processes. Various language models may be used to generate outputs based on input text and a prediction of the output, informed by training datasets. Large language models include neural networks that utilize the transformer architecture. Large language models are an example of generative artificial intelligence, producing a text output based on a defined text prompt.

The term “internal agent” may refer to LLMs and/or other artificial intelligence models that are hosted by the entity deploying the user input routing system. The internal agent may be trained using entity specific training data and may be able to access other systems, servers, and/or databases on the entities secure network.

The term “external agent” may refer to LLMs and/or other artificial intelligence models that are hosted externally from the entity deploying the user input routing systems. The external agent may be publicly accessible LLMs (e.g., GPT-4o, PaLM 2, Grok-1, Gemini, etc.). They may be hosted on the internet and may not have access to secure systems, servers, and/or databases of the entity.

### System Architecture

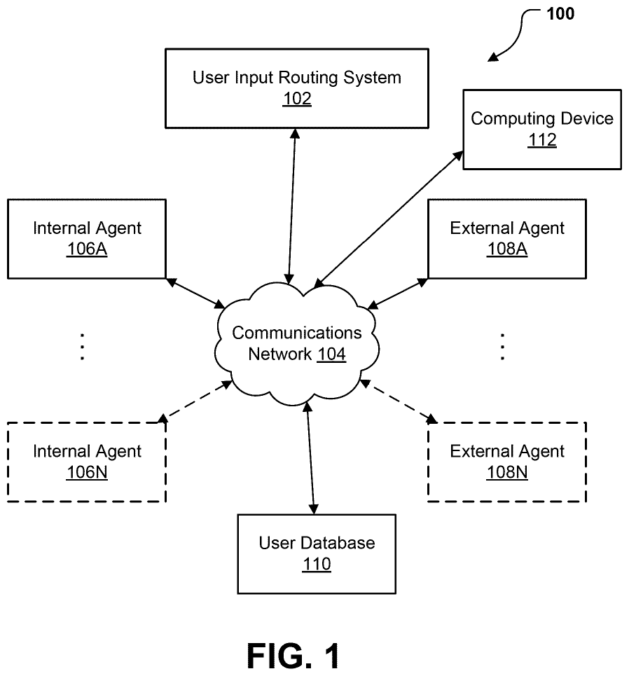

Example embodiments described herein may be implemented using any of a variety of computing devices or servers. To this end, FIG. 1 illustrates an example environment 100 within which various embodiments may operate. As illustrated, a user input routing system 102 may receive and/or transmit information via communications network 104 (e.g., the Internet, local area network (LAN)) with any number of other devices, such as one or more of internal agents 106A-106N and/or external agents 108A-108N.

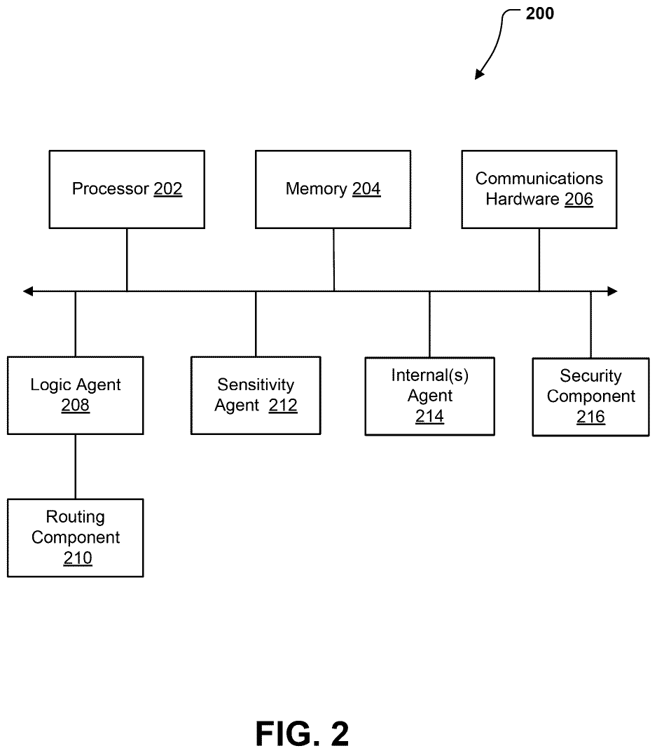

The user input routing system 102 may be implemented as one or more computing devices or servers, which may be composed of a series of components. Particular components of the user input routing system 102 are described in greater detail below with reference to apparatus 200 in connection with FIG. 2.

In some embodiments, the user input routing system 102 further includes a storage device (e.g., user database 110) that comprises a distinct component from other components of the user input routing system 102. User database 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). User database 110 may store information relied upon during operation of the user input routing system 102, such as access to additional user information and/or data that may be used by the user input routing system 102, data and documents to be analyzed using the user input routing system 102, or the like.

The one or more internal agent(s) 106A-106N and the one or more external agent(s) 108A-108N may be embodied by any computing devices known in the art. The one or more internal agent(s) 106A-106N and the one or more external agent(s) 108A-108N need not themselves be independent devices but may be peripheral devices communicatively coupled to other computing devices.

Although FIG. 1 illustrates an environment and implementation in which the user input routing system 102 interacts indirectly with a user computing device 112, in some embodiments users may directly interact with the user input routing system 102 (e.g., via communications hardware of the user input routing system 102), in which case a separate computing device 112 may not be utilized. Whether by way of direct interaction or indirect interaction via another device, a user may communicate with, operate, control, modify, or otherwise interact with the user input routing system 102 to perform the various functions and achieve the various benefits described herein.

### Example Implementing Apparatuses

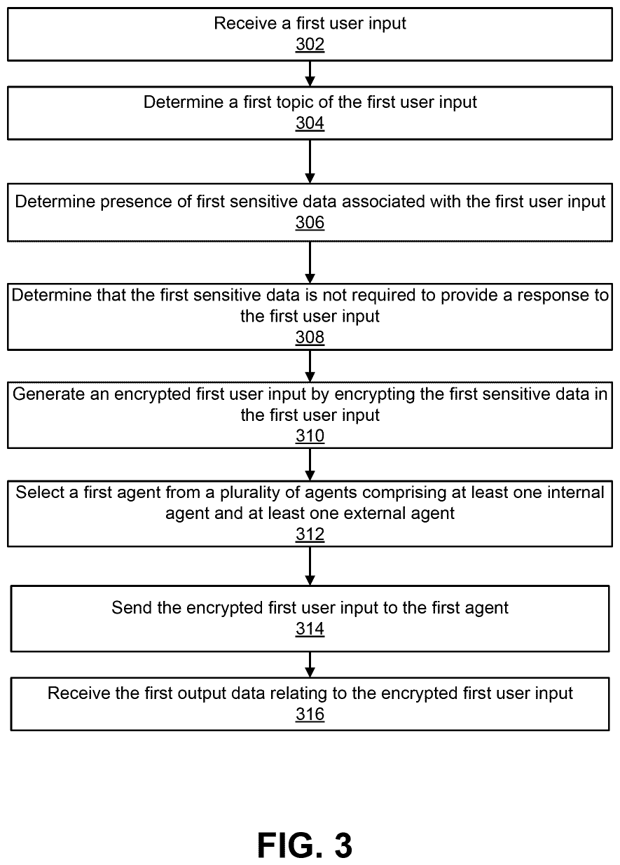

The user input routing system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-7. As illustrated in FIG. 2, the apparatus 200 may include processor 202, memory 204, communications hardware 206, logic agent 208, routing component 210, and sensitivity agent 212, internal agent 214, and security component 216 each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

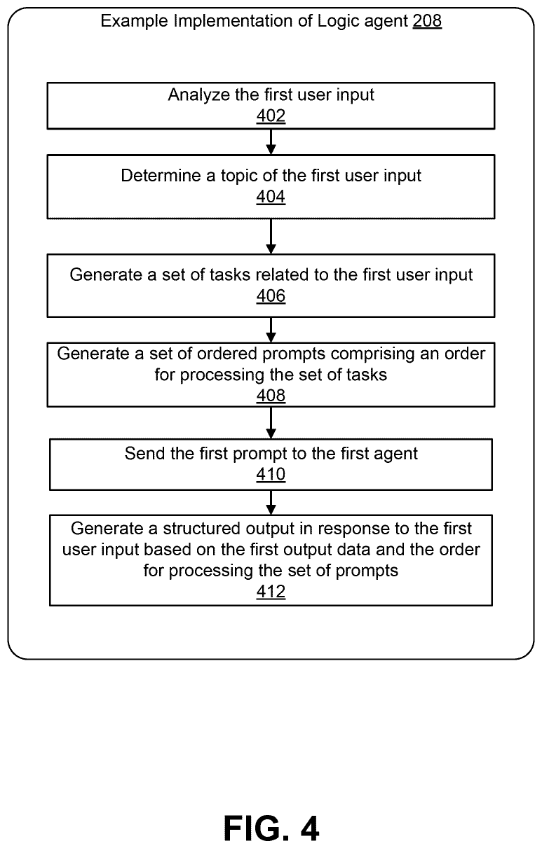

In addition, the apparatus 200 further comprises a logic agent 208 that may determine the topic of the first user input. The logic agent 208 may generate a set of tasks related to the first user input. The logic agent 208 may generate a set of ordered prompts for the processing of the set of tasks. The logic agent 208 may utilize processor 202, memory 204, or any other hardware component included in the apparatus 200 to perform these operations, as described in connection with FIGS. 3 and 4 below. The logic agent 208 may further utilize communications hardware 206 to gather data from a variety of sources (e.g., internal agent 106A-N, and/or external agent 108A-N, as shown in FIG. 1), and/or exchange data with a user, and in some embodiments may utilize processor 202 and/or memory 204 to generate a structured output in response to the first user input. In various embodiments, logic agent 208 may comprise a pre-trained LLM that has been fine-tuned using historical input data (e.g., audio and/or text transcripts of past user inputs) along with data labelling the topic of the input and data identifying the one or more internal agents and/or external agents to which the past user input (or individual tasks and/or portions of the prompt) was routed, along with the respective responses generated by the selected agents. The training data may also contain accuracy information regarding the responses generated by the selected agent. This may allow for the LLM to determine the best form for combining multiple outputs of agents. Additionally, related tasks and prompts for historical user inputs may be provided, along with the historical user inputs. Accordingly, during fine-tuning the logic agent 208 may learn not only the topics of a user input, but also learn how to generate a set of tasks related to the user input. Tasks may be questions relating the first user input, instructions relating to the first user input, API calls to connected services in relation to the first user input, etc. The logic agent 208 may also learn to generate a set of ordered prompts relating to the set of tasks. The set of ordered prompts may be designed to generate responses to the various tasks within the set of tasks. Using such a fine-tuning dataset, the logic agent 208 may be trained using techniques such as supervised learning to adjust various parameters of the model (e.g., model weights and/or biases) using back propagation and gradient descent to minimize the loss function (representing a difference between the model's generated output and the actual labels included in the fine-tuning dataset).

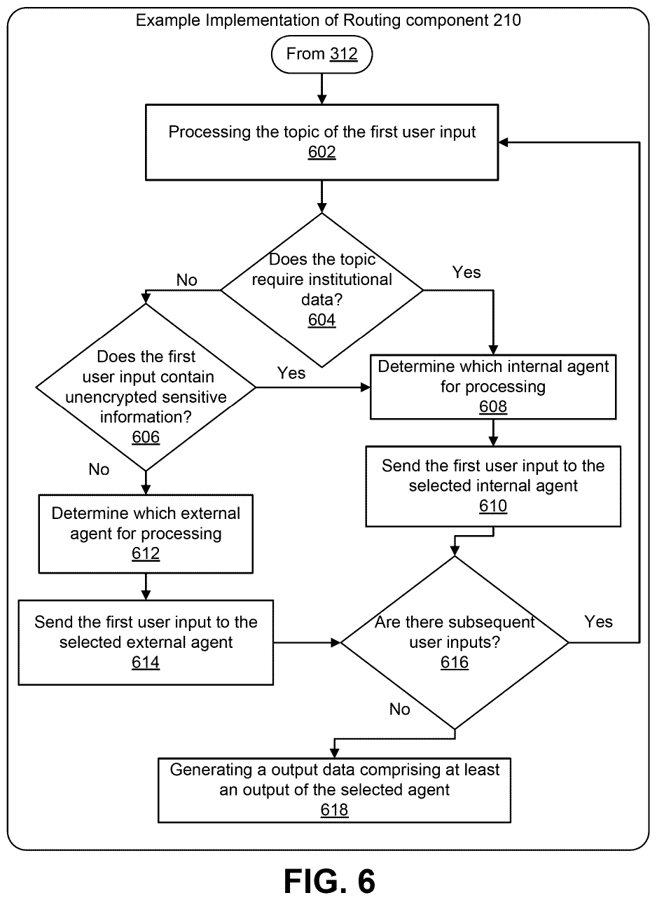

In addition, the apparatus 200 further comprises a routing component 210 that selects a first agent from a plurality of agents comprising at least one internal agent and at least one external agent. The routing component 210 may utilize processor 202, memory 204, or any other hardware component included in the apparatus 200 to perform these operations, as described in connection with FIGS. 3 and 6 below. The routing component 210 may further utilize communications hardware 206 to gather data from a variety of sources (e.g., the logic agent 208). In some embodiments, the routing component 210 may be used by the logic agent to select the agent for the processing of user input. The routing agent may comprise data relating to the available internal agent(s) 106A-106N and the available external agent(s) 108A-108N. The routing component 210 may be an LLM-based classifier, that has been fine-tuned using historical input data (e.g., audio and/or text transcripts of past user inputs) identifying the one or more internal agents and/or external agents to which the past user input (or individual questions and/or portions of the prompt) was routed. The training data may also include annotation (e.g., a score) related to the quality of the response generated by the LLM to which it was routed. This allows for the logic agent to learn and intelligently route the user input to the best available agent for processing.

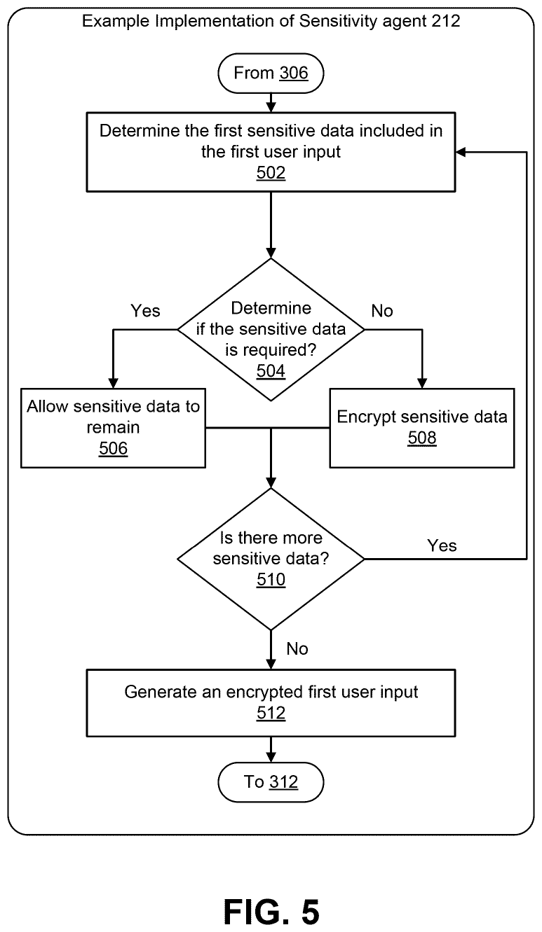

In addition, the apparatus 200 further comprises a sensitivity agent 212 that may determine the presence of sensitive data associated with the first user input. The sensitivity agent 212 may determine whether the sensitive data is required to provide a response to the first user input related. The sensitivity agent 212 may utilize processor 202, memory 204, or any other hardware component included in the apparatus 200 to perform these operations, as described in connection with FIGS. 3 and 5 below. The sensitivity agent 212 may further utilize communications hardware 206 to gather data from a variety of sources (e.g., the logic agent 208), and/or exchange data with a user, and in some embodiments may utilize processor 202 and/or memory 204 to generate an encrypted user input by encrypting the sensitive data. In various embodiments, sensitivity agent 212 may comprise a pre-trained LLM that has been fine-tuned using historical input data (e.g., audio and/or text transcripts of past user inputs) along with data labelling the sensitive data. Additionally, the historical input data may include data labelling whether the sensitive data may be required to provide a response to the user input, along with the historical user inputs. Using such a fine-tuning dataset, the sensitivity agent 212 may be trained using techniques such as supervised learning to adjust various parameters of the model (e.g., model weights and/or biases) using back propagation and gradient descent to minimize the loss function (representing a difference between the model's generated output and the actual labels included in the fine-tuning dataset). In various embodiments, the sensitivity agent 212 may also determine the presence of potentially biasing information in the first user input. The pre-trained LLM may be fine-tuned to detect potentially biasing information through training with labelled biasing information. In various embodiments, the sensitivity agent 212 may encrypt potentially biasing information.

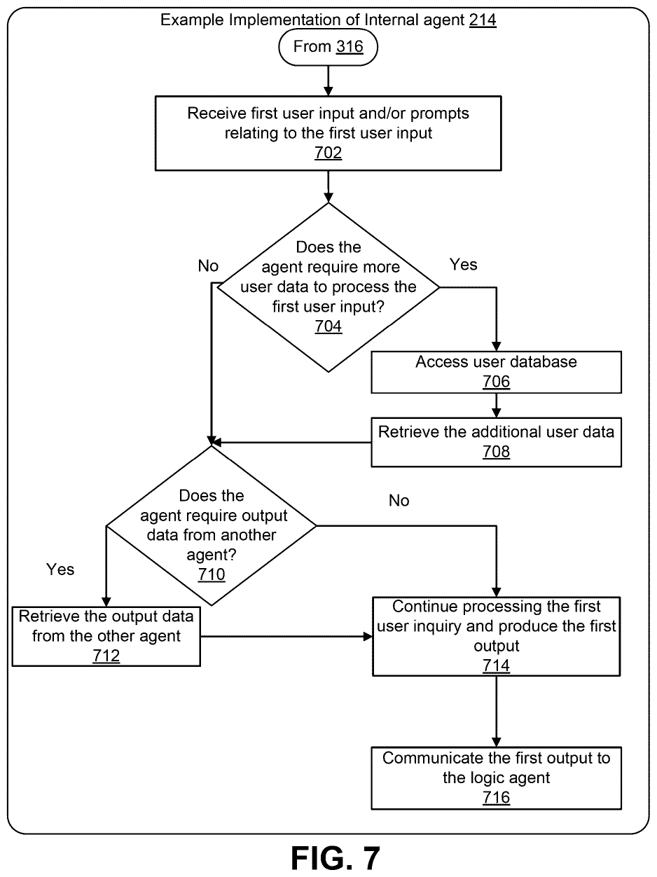

In addition, the apparatus 200 further comprises an internal agent(s) 214 that may process user input and generate a response. In various embodiments, the internal agent 214 may comprise a plurality of internal agents (e.g., internal agent 106A-106N, see FIG. 1), which may contain specific detailed information. The internal agent(s) 214 may utilize processor 202, memory 204, or any other hardware component included in the apparatus 200 to perform these operations, as described in connection with FIGS. 3 and 7 below. The internal agent(s) 214 may further utilize communications hardware 206 to gather data from a variety of sources (e.g., the routing component 210), and in some embodiments may utilize processor 202 and/or memory 204 to generate a response to the user input. The internal agent(s) 214 may comprise a pre-trained LLM. The pre-trained LLM may be trained on data relating to specific data to the entity running the user input routing system 102. The training data may include data regarding the entities services and products, alongside institutional information. The internal agent(s) 214 may be trained using techniques such as supervised learning to adjust various parameters of the model (e.g., model weights and/or biases) using back propagation and gradient descent to minimize the loss function (representing a difference between the model's generated output and the actual labels included in the fine-tuning dataset) to provide a response to the user input.

Further, the apparatus 200 further comprises a security component 216 that may prevent the internal agent(s) 214 from accessing external data sources base on the presence of sensitive data in the user input. The security component 216 may utilize processor 202, memory 204, or any other hardware component included in the apparatus 200 to perform these operations, as described in connection with FIG. 3 below. The security component 216 may further utilize communications hardware 206 to gather data from a variety of sources (e.g., internal agent(s) 214), and/or exchange data with a user, and in some embodiments may utilize processor 202 and/or memory 204 to prevent the internal agent from accessing external data.

Although components 202-216 are described in part using functional language, it will be understood that the particular implementations necessarily include the use of particular hardware. It should also be understood that certain of these components 202-216 may include similar or common hardware. For example, the logic agent 208, routing component 210, sensitivity agent 212, internal agent(s) 214, and security component 216 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “agent” and “component” with respect to elements of the apparatus therefore shall be interpreted as necessarily including the particular hardware configured to perform the functions associated with the particular element being described. Of course, while the terms “agent” and “component” should be understood broadly to include hardware, in some embodiments, the terms “agent” and “component” may in addition refer to software instructions that configure the hardware components of the apparatus 200 to perform the various functions described herein.

Although the logic agent 208, routing component 210, sensitivity agent 212, internal agent(s) 214, and security component 216 may leverage processor 202, memory 204, or communications hardware 206 as described above, it will be understood that any the logic agent 208, routing component 210, sensitivity agent 212, internal agent(s) 214, and security component 216 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the logic agent 208, routing component 210, sensitivity agent 212, internal agent(s) 214, and security component 216 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components (e.g., the internal agent(s) 214) of the apparatus 200 may not be physically proximate to the other components (e.g., the logic agent 208) of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200 example embodiments are described below in connection with a series of flowcharts.

### Example Operations

Turning to FIGS. 3-7, example flowcharts are illustrated that contain example operations implemented by example embodiments described herein. The operations illustrated in FIGS. 3-7 may, for example, be performed by the user input routing system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, the logic agent 208, routing component 210, sensitivity agent 212, internal agent(s) 214, security component 216 and/or any combination thereof. It will be understood that user interaction with the user input routing system 102 may occur directly via communications hardware 206, as shown in FIG. 1, and which may have similar or equivalent physical componentry facilitating such user interaction.

Turning to FIG. 3, example operations are shown for the routing of a first user input to an agent.

As shown by operation 302, the apparatus 200 includes means, such as processor 202, memory 204, communications hardware 206, or the like, for receiving a first user input. In various embodiments, the communications hardware 206 may receive from sensors (e.g., one or more microphones, cameras, etc.) a user input and/or from a connected computing device 112 a text-based user input. In various embodiments, the user input may be captured from a user interaction with an employee of the entity deploying the user input routing system 102. In some embodiments, the user input may be received from a connected computing device 112. The connected computing device 112 may be a user device that may communicate the user input routing system via communications network 104 (see FIG. 1).

As shown by operation 304, the apparatus 200 includes means, such as processor 202, memory 204, communications hardware 206, logic agent 208, or the like, for determining a first topic of the first user input. In various embodiments, the logic agent 208 may use an automatic speech recognition (ASR) system to generate a text transcript of the first user input, in an instance where the first user input is captured by a microphone. The logic agent 208 may determine the topic of the first user input based on the text transcript of the first user input. The logic agent 208 may comprise a LLM that may process the text transcript of the first user input and output a determined first topic. For example, the user input nay be a conversation between the user and an employee. The conversation may include an inquiry regarding the interest rate the user may get if they applied for a mortgage. The logic agent 208 may determine that “mortgage” is the first topic of the user input. In another example, the logic agent 208 may receive a first user input from a computing device 112. The first user input contains a question regarding the interest rate on savings accounts. The logic agent may determine the first topic of the first user input, in this case, is “savings”.

As shown by operation 306, the apparatus 200 includes means, such as processor 202, memory 204, communications hardware 206, sensitivity agent 212, or the like, for determining the presence of first sensitive data associated with the first user input. In various embodiments, the first user input may contain a variety of information provided by the user. The sensitivity agent 212 may parse the text transcript of the first user input and determine the presence of sensitive data. Examples of sensitive data may include personally identifiable information (PII) (e.g., name, address, social security number, etc.), account information (e.g., account number, account content, or the like), etc. For example, the first user input may pertain to a mortgage application for the user. The first user input may include a mention of the user's name and current address alongside an account number and a savings account balance. The sensitivity agent 212 may determine that there is sensitive information in the first user input. If for example, the first user input was a question regarding the current mortgage rates offered by the bank and included no sensitive data. The sensitivity agent 212 may determine that there is no sensitive information in this case. In some embodiments, the sensitivity agent 212 may determine the presence of potentially biasing language and/or information in the first user input. For example, the first user input may include information regarding the address of the user. The address may be in a disreputable neighborhood that may be a source of bias in decision making process.

As shown by operation 308, the apparatus 200 includes means, such as processor 202, memory 204, communications hardware 206, sensitivity agent 212, or the like, for determining that the first sensitive data is not required to provide a response to the first user input. In some embodiments, the sensitivity agent 212 may use the text transcript of the first user input to determine if the first sensitive data included in the first user input is required to provide a response to the first user input. For example, the first user input may include a question relating to the interest rates on various savings accounts, the user may have presented sensitive data such as full name, address and credit score in the first user data. The sensitivity agent 212 may determine that the sensitive data included in the first user input is not required for subsequent processing by the processing agent (e.g., internal agent 106A-106N and/or external agent 108A-108N). In some embodiments, the sensitivity agent may determine that the sensitive data is required to provide a response to the first user input. For example, the first user input may include a question regarding the mortgage rate the user would be eligible for at the bank. Included in the first user input may be sensitive information such as their name, credit score, amount of savings, and their current address. The sensitivity agent 212 may determine that this information may be required by the processing agent (e.g., internal agent 106A-106N and/or external agent 108A-108N) to provide a response to the first user input. For example, the mortgage rate for the user may depend on the user's credit score and amount of savings.

As shown by operation 310, the apparatus 200 includes means, such as processor 202, memory 204, communications hardware 206, sensitivity agent 212, or the like, for generating an encrypted first user input by encrypting the first sensitive data in the first user input. In various embodiments, the sensitivity agent 212 may generate an encrypted first user input from the text transcript of the user input. For example, if the first user input may include a question regarding the mortgage rate the user would be eligible for at the bank, the user may have provided current address information and the address of the house the user intends to purchase. The sensitivity agent may determine that the current address information and the address of the house the user intends to purchase are not required to respond to the user input. As such, the sensitivity agent 212 may encrypt the address data identified in the text transcript of the user input and generate the encrypted first user input including the encrypted address data. In various embodiments, the sensitivity agent 212 may use a variety of encryption methods to encrypt, redact and/or otherwise obfuscate the address data. For example, the sensitivity agent 212 may use a one-way hashing algorithm to generate a hash value for the address data. The hash value for the address data is generated by replacing the sensitive data with a fixed length string of letters and numbers. The sensitivity agent 212 may use the generated hash value in the place of the sensitive data in the first user input, generating an encrypted first user input. In some embodiments, the sensitivity agent 212 may also encrypt potential sources of bias included in the first user input.

As shown by operation 312, the apparatus 200 includes means, such as processor 202, memory 204, communications hardware 206, logic agent 208, routing component 210, or the like, for selecting a first agent from a plurality of agents comprising at least one internal agent 106A and at least one external agent 108A (see FIG. 1). In various embodiments, the logic agent 208 may use the routing component 210, to select the first agent for processing the first user input. The routing agent may include information regarding the available internal agent(s) (e.g., internal agent 106A-106N) and the available external agent(s) (e.g., external agent 108A-108N). The routing component 210 may also include information about the various topics each available agent(s) may be best suited to provide a response to. The routing component 210 may use the information regarding the available agent(s) to select the processing agent for the first user input. In some embodiments, the routing component 210 may further use the topic of the first user input to select the first agent for processing of the first user input. For example, the first user input may relate to the user's mortgage application. The logic agent 208 may have determined the user input topic as “mortgage”. The entity deploying the user input routing system 102, may have a mortgage internal agent (e.g., internal agent 106A). The mortgage internal agent 106A may have been trained on the entity specific mortgage data and information. The routing component 210 may select the mortgage internal agent 106A for the processing of the user input. In another embodiment, the routing agent may also use information regarding the presence of the first sensitive data in the selection of agent. For example, if the first user input contains sensitive data that has not been encrypted, by the sensitivity agent 212, the routing agent may select only from the internal agent(s).

As shown by operation 314, the apparatus 200 includes means, such as processor 202, memory 204, communications hardware 206, routing component 210, or the like, for sending the encrypted first user input to the first agent. In various embodiments, the routing component 210 may use the communications hardware 206 to send the encrypted first user data to the selected agent for processing, the selected agent may be an internal agent (e.g., internal agent 106A-106N) or an external agent (e.g., external agent 108A-108N). Encrypted first user data may be sent to an internal agent to reduce the security risk, if the sensitivity agent 212 determines that the sensitive data would not be useful to provide a response to the first user input. In some embodiments, the routing component 210 may send the unencrypted first user input to the first agent, if the sensitivity agent 212 does not determine the presence of first sensitive data. In another embodiment, the routing component 210 may send the unencrypted first user input to a selected internal agent (e.g., internal agent 106A-106N), if the sensitivity agent 212 determines the first sensitive data would be useful to provide a response to the first user input.

As shown by operation 316, the apparatus 200 includes means, such as processor 202, memory 204, communications hardware 206, logic agent 208 or the like, for receiving, from the first agent, the first output data relating to the encrypted first user input. In various embodiments, the logic agent 208 may receive the output of the first agent. The first agent (e.g., internal agent 106A-106N and/or external agent 108A-108N) may process the encrypted user input and may generate an output in response. For example, the first user input may include a question relating to the interest rates of saving accounts, the user input may contain unnecessary sensitive data such as the credit score of the user, which may be removed through the encryption process. The first agent may be a savings specific internal agent (e.g., internal agent 106A). The savings specific internal agent 106A may generate a response including information relating to the current interest rates of the savings accounts offered by the bank. The output of the savings specific internal agent 106A may be sent via communications hardware 206 to the logic agent 208. In some embodiments, the first output data relating to the encrypted first user input may be communicated to the user. In an instance where the first user input is detected in a facility operating the user input routing system 102, the communications hardware 206 may send a notification of the first output data to be displayed on a computing device (e.g., computing device 112) in the facility. The computing device 112 may be directly accessible by the user and/or may be accessible by an employee of the institution operating the user input routing system 102.

In some embodiments, the logic agent 208 may perform operations in accordance with the operations described by FIG. 4. Turning now to FIG. 4, example operations are shown for the generation of prompts from the first user input.

As shown by operation 402, the apparatus 200 includes means, such as processor 202, memory 204, communications hardware 206, logic agent 208, or the like, for analyzing the first user input. In various embodiments, the logic agent 208 may receive first user input from the communications hardware 206. In various examples, the first user input may be audio data captured from an interaction of the user and an employee, the logic agent may use automatic speech recognition to generate a text representation of the audio data. In various other examples, the first user input may be text data sent from a user device (e.g., computing device 112) to the user input routing system 102.

As shown by operation 404, the apparatus 200 includes means, such as processor 202, memory 204, communications hardware 206, logic agent 208, or the like, for determining the topic of the first user input. In various embodiments, the logic agent 208 may analyze the text transcript of the first user input to determine the topic. For example, the user input may be a conversation between the user and an employee. The conversation may include an inquiry regarding the interest rate the user may get if they applied for a mortgage. The logic agent 208 may determine that “mortgage” is the first topic of the user input.

As shown by operation 406, the apparatus 200 includes means, such as processor 202, memory 204, communications hardware 206, logic agent 208, or the like, for generating a set of tasks related to the first user input. In various embodiments, the logic agent 208 may use natural language processing to determine tasks related to the first user input. The tasks may be a variety of steps that the internal agent 106A-106N and/or external agent 108A-108N need to generate a response to the first user input. In some embodiments, tasks may be questions that need an answer to provide a response to the first user. The questions may be contained within the first user input. For example, the first user input may contain a direct question relating to the interest rates of savings accounts (e.g., “What is the highest interest rate your institution offers on savings accounts?”). In other embodiments, the logic agent 208 may determine questions that may be associated and/or relevant to the first user input. For example, the user input may contain a question relating to the interest rate the user may be offered (e.g., “What mortgage rate would you offer me?”). The logic agent 208 may determine some associated questions that may need to be answered to provide an informative response to the first user input. For example, the logic agent 208 may determine questions such as “what is the Federal Reserve interest rate?” and/or “What is the user's yearly salary?” may need to be answered to generate an informative response to the first user input. In some embodiments, the logic agent 208 may use the encrypted first user input generated by the sensitivity agent 212 to generate the set of tasks. The set of tasks may contain questions to provide a response to the first user input. In some embodiments, the logic agent 208 may use unencrypted first user input to generate the set of tasks, if the sensitivity agent 212 determined the sensitive information is required to provide a response to the first input. For example, if the first user input related to the mortgage rate the user may be offered the set of questions may include questions such as “what is the Federal Reserve interest rate?”, “what is the user's credit score?”, “how much savings does the user have?”, “what is the range on interest rates the bank is currently offering for mortgages?”, etc. In some embodiments, the generated tasks may be instructions to the agent (e.g., internal agent 106A-106N and/or external agent 108A-108N). For example, the first user input relating to mortgage application, one instruction may be to check the user's assets. In some embodiments, the tasks may be an API call. For example, if the user input relates to sending a payment overseas, the task may be an API call to Google Finance, for example, to determine the current exchange rates. In some embodiments the logic agent 208, may determine the topics for the individual tasks in the set of tasks. As such tasks and prompts related to the first user input may be routed according to their determined topics.

As shown by operation 408, the apparatus 200 includes means, such as processor 202, memory 204, communications hardware 206, logic agent 208, or the like, for generating a set of ordered prompts comprising an order for processing the set of tasks. In various embodiments, the logic agent 208 may use the set of tasks, generated by operation 408, to generate a set of ordered prompts. The logic agent 208 may generate the prompts based on the tasks in the set of tasks. The prompts may be designed by the logic agent 208 to produce a concise and accurate response from the selected agent(s) (e.g., internal agent 106A-106N and/or external agent 108A-108N). For example, if the set of tasks include a question “what is the range on interest rates the bank is currently offering for mortgages?” the logic agent may generate a prompt “looking at the most recent data, what is the range of mortgages rates the bank have offered to users”. In another example, if the set of tasks include an API call to Google Finance to determine the exchange rate. The logic agent may generate a prompt “determine using Google Finance API, the exchange rate from USD to GBP”. In various embodiments, the generated prompts may incorporate multiple tasks in a single prompt, this may be done for tasks that have the same determined topic that may be processed by the same agent (e.g., internal agent 106A-106N and/or external agent 108A-108N). For example, the set of tasks may include an API call to determine the current USD to GBP exchange rate, and an instruction to calculate the amount of USD required to send £100 GBP. The logic agent 208 may generate a single prompt designed to provide the required response by the selected agent (e.g., “Using Google Finance determine the current exchange rate of USD to GBP and using the exchange rate calculate how much USD is required to send £100 GBP”. In various embodiments, the logic agent 208 may determine the order in which the prompts should be processed by the processing agent(s) (e.g., internal agent 106A-106N and/or external agent 108A-108N). For example, the logic agent 208 may generate 5 prompts based on the set of tasks, the 4^{th} prompt may rely on the output of the 5^{th} prompt. In the set of ordered prompts the 5^{th} prompt may be before the 4^{th} prompt.

As shown by operation 410, the apparatus 200 includes means, such as processor 202, memory 204, communications hardware 206, logic agent 208, routing component 210, or the like, for sending the first prompt to the first agent, wherein the first agent generates the first output data based on the first prompt. In various embodiments, the logic agent 208 may communicate the set of ordered prompts to the routing component 210. The routing component 210 may select the first agent (e.g., internal agent 106A-106N and/or external agent 108A-108N) for the processing of the first prompt of the set of ordered prompts. In some embodiments, the routing component 210 may select one agent for the processing of the prompts comprising the set of ordered prompts. For example, if the set of ordered prompts relates to the mortgage rates offered by the bank. The routing component 210 may determine the mortgage specific internal agent may provide an accurate response. In various embodiments, the routing component 210 may select different agents for the processing for each prompt of the set of ordered prompts. For example, if the set of ordered prompts relates to the international transfer of funds. The routing component may select a transfer specialized internal agent that may provide information regarding the fees associated with such a transfer and an external agent that may provide legal information regarding the amount of money transferred or the like.

As shown by operation 412, the apparatus 200 includes means, such as processor 202, memory 204, communications hardware 206, logic agent 208, or the like, for generating a structured output in response to the first user input based on the first output data and the order for processing the set of prompts. In various embodiments, the logic agent may receive the output from the first agent and produce a structured output, which may be communicated to the user. In some embodiments, the structured output may be sent to a computing device (e.g., computing device 112) of the employee engaged with receiving the first user input. In other embodiments, the structured output may be sent directly to the user device (e.g., computing device 112). In an instance where there are multiple prompts comprising the set of ordered prompts, the output generated by the first agent (e.g., internal agent 106A-106N and/or external agent 108A-108N) in response to each prompt may be sent to the logic agent 208. The logic agent 208 may process the various outputs received in response to the first user input and generate a structured output. The structured output may be based on the order of processing. The structured output generated by the logic agent 208 may provide a readable concise response to the first user input. For example, in an instance where the first user input relates to the transfer of £100 GBP from the users account. The structured output may start with the current exchange rate, followed by the associated account fees, followed by the amount of USD required to complete the transfer, followed by an estimate of the time until the transfer completes, and a legal disclaimer.

In some embodiments, the sensitivity agent 212 may perform operations in accordance with the operations described by FIG. 5. Turning now to FIG. 5, example operations are shown for the determination of the presence of the first sensitive data and where the first sensitive data is required to respond to the first user input.

As shown by operation 502, the apparatus 200 includes means, such as processor 202, memory 204, communications hardware 206, sensitivity agent 212, or the like, for determining the presence of first sensitive data included in the first user input. In various embodiments, the sensitivity agent 212 may determine the presence of first sensitive data included in the first user input by parsing the text transcript of the first user input. The sensitivity agent 212 may use natural language processing to detect the presence of sensitive data in the text transcript of the first user input. For example, the text transcript of the first user input may include the name, address and social security number of the user. The sensitivity agent 212 may identify this data as sensitive data.

As shown by operation 504, the apparatus 200 includes means, such as processor 202, memory 204, communications hardware 206, sensitivity agent 212, or the like, for determining if the sensitive data is required. In some embodiments, the sensitivity agent 212 may determine if the sensitive data, present in the first input, may be useful to provide a response to the first user input. The sensitivity agent 212 may use natural language processing and training to determine what information is required to respond to the first user input. In an instance where the sensitivity agent 212 determines the first sensitive data is required to respond to the first user input. For example, the first user input relates to the mortgage rate available to the user, the first sensitive data may be the users credit score. The sensitivity agent 212 may determine that this information would be useful to respond to the user input. In this instance the process may continue with operation 506. In an instance where the sensitivity agent 212 determines the first sensitive data is not required to respond to the first user input. For example, the first user input relates to the interest rates available in the various accounts the bank offers, the first sensitive data may be the name and address of the user. The sensitivity agent 212 may determine that this information would not be useful to respond to the use input. In this instance the process may continue with operation 508.

As shown by operation 506, the apparatus 200 includes means, such as processor 202, memory 204, communications hardware 206, sensitivity agent 212, or the like, for allowing the sensitive data to remain. In some embodiments, the sensitivity agent 212 may allow for sensitive data to remain in the first user input. The sensitivity agent 212 may determine that the sensitive data is required to respond to the first user input. For example, if the first user input contains the credit score of the user and the first user input relates to a request for the loan options. The sensitivity agent 212 may allow for the credit score to remain in the first user input.

As shown by operation 508, the apparatus 200 includes means, such as processor 202, memory 204, communications hardware 206, sensitivity agent 212, or the like, for encrypting sensitive data. In various embodiments, the sensitivity agent 212 may encrypt the sensitive data to remove the sensitive data from further processing. In some embodiments, the sensitivity agent 212 may use a hashing algorithm to hash the sensitive data and replace it with a hash value. In other embodiments, the sensitivity agent 212 may use a substitution cypher to generate cypher text of the sensitivity data. For example, the first user input may relate to the interest rates available in various savings accounts offered by the bank, the first sensitive data may be the name and address of the user. The sensitivity agent 212 may use a hashing algorithm to hash the name and address of the user and replace it with a hash value.

As shown by operation 510, the apparatus 200 includes means, such as processor 202, memory 204, communications hardware 206, sensitivity agent 212, or the like, for determining if there is more sensitive data. In some embodiments, the sensitivity agent 212 may determine if there is further sensitive data included in the first user input. In an instance where the sensitivity agent determines that there is more sensitive data in the first user input the process may return to operation 502 for the second sensitive data. For example, if the first user input relates to the mortgage rates available to the user, the first sensitive data may be the name and address of the user. The first user input may also include the credit score of the user. The sensitivity agent 212 may begin the processing of whether the credit score may be useful in producing a response to the first user input at operation 502. In an instance in which the sensitivity agent 212 determines, by parsing the first user input, that there are no more instances of sensitive data. The process may continue at operation 512.

As shown by operation 512, the apparatus 200 includes means, such as processor 202, memory 204, communications hardware 206, sensitivity agent 212, or the like, for generating an encrypted first user input. In various embodiments, the sensitivity agent may generate an encrypted first user input wherein the sensitive data contained within the first user input is removed and/or replaced. In some embodiments, the sensitive data may be replaced by cypher text. In other embodiments, the sensitive data may be replaced by a hash value generated by one way hashing of sensitive data. For example, if the first user input relates to the mortgage rates available to the user. The sensitive first sensitive data may be the users name and address, which the sensitivity agent 212 may determine is not useful in producing a response. In the encrypted first user input this may be replaced with a hash value or cypher text. The second sensitive data may be the credit score, which the sensitivity agent 212 may determine would be useful in producing a response as such this may be left unencrypted in the encrypted first user input. In this case the routing component 210 would be limited to internal agents (e.g., internal agent 106A-106N), to minimize the risk.

In some embodiments, the logic agent 208 may use the routing component 210 to perform operations in accordance with the operations described by FIG. 6. Turning now to FIG. 6, example operations are shown for the selection of the first agent for the processing of the first user input.

As shown by operation 602, the apparatus 200 includes means, such as processor 202, memory 204, communications hardware 206, logic agent 208, routing component 210, or the like, for processing the topic of the first user input. In various embodiments, the logic agent 208 may determine the topic of the first user input as described above in relation to FIG. 4. The routing component 210 may process the topic of the first user input. In some embodiments, the routing component 210 may process the topic of the generated ordered prompts from the logic agent 208.

As shown by operation 604, the apparatus 200 includes means, such as processor 202, memory 204, communications hardware 206, routing component 210, or the like, for determining if the topic requires institutional data. In various embodiments, the routing component 210 may determine if institutional data is required to provide a response to the first user input. The routing component 210 may use the information regarding internal agent(s) (e.g., internal agent 106A-106N) and the external agent(s) (e.g., external agent 108A-108N). The information regarding the agents may include the information each agent may contain. For example, an external agent 108A-108N may include general information whereas mortgage specific internal agent 106A may include specific institutional information relating to mortgages. In an instance where the routing component 210 determines the topic does not require institutional data the process may continue at operation 606. In an instance where routing component 210 determines the topic does require institutional data the process may continue at operation 608.

As shown by operation 606, the apparatus 200 includes means, such as processor 202, memory 204, communications hardware 206, routing component 210, or the like, for determining if the first user input contains unencrypted sensitive information. The routing component 210 may receive from the sensitivity agent 212 a determination of the presence of unencrypted sensitive data. For example, if the first user input relates to the mortgage rates available to the user, the unencrypted sensitive data may be the credit score of the user. In an instance where the routing component 210 determines that the first user input should be processed by an external agent 108A and there is unencrypted sensitive data, the routing component 210 may send the first user input to the sensitivity agent 212 for encryption. In an instance where there is no unencrypted sensitive data included in the first user input the process may continue at operation 612. In an instance where there is it is determined there is unencrypted sensitive data included in the first user input the process may continue at operation 608.

As shown by operation 608, the apparatus 200 includes means, such as processor 202, memory 204, communications hardware 206, routing component 210, or the like, for determining which internal agent to select for processing of the first user input. In various embodiments, the routing component 210 may use the information regarding the internal agents (e.g., internal agent 106A-106N) to determine which internal agent would provide an appropriate response to the first user input. The routing component 210 may use the topic of the first user input to determine which internal agent would provide the required institutional data and provide an appropriate response. For example, the topic of the first user input is determined as “mortgage” in this example, the routing component 210 may determine the mortgage specific internal agent may contain the institutional information required to provide an appropriate response.

As shown by operation 610, the apparatus 200 includes means, such as processor 202, memory 204, communications hardware 206, routing component 210, or the like, for sending the first user input to the selected internal agent 106A-106N. In some embodiments, the routing component 210 may send the first user input to the selected internal agent 106A-106N, via the communications hardware 206.

As shown by operation 612, the apparatus 200 includes means, such as processor 202, memory 204, communications hardware 206, routing component 210, or the like, for determining which external agent 108A-108N for processing first user input. In various embodiments, the routing component 210 may use the information regarding the external agent(s) (108A-108N) to determine which external agent (108A-108N) may provide an appropriate response to the first user input. For example, one external agent 108A may be a publicly available large language model containing large volume of data. In another example, another external agent 108N may be a large language model developed by financial institutions to provide broad information regarding banking and finance. The routing component 210 may determine, based on the topic of the first user input, which external agent 108A-108N may provide an appropriate response.

As shown by operation 614, the apparatus 200 includes means, such as processor 202, memory 204, communications hardware 206, routing component 210, or the like, for sending the first user input to the selected external agent 108A-108N. In some embodiments, the routing component 210 may send the first user input to the selected external agent 108A-108N, via the communications hardware 206.

As shown by operation 616, the apparatus 200 includes means, such as processor 202, memory 204, communications hardware 206, routing component 210, or the like, for determining if there are subsequent user inputs. In some embodiments, the routing agent may determine if there are more user inputs for processing by the user input routing system 102. For example, the first user input may be followed by a second user input. The first user input may relate to mortgage rates and the second user input may relate to whether mortgage insurance would be required. If there are more user inputs the process may continue at operation 602 for the next user input. In an instance where there are no more user inputs the process may continue at operation 618.

As shown by operation 618, the apparatus 200 includes means, such as processor 202, memory 204, communications hardware 206, logic agent 208, or the like, for generating output data comprising at least an output of the selected agent. In various embodiments, the selected agent (e.g., internal agent 106A-106N and/or external agent 108A-108N) may generate an output in response to the first user input. For example, the first user input may relate to the mortgage rates available to the user. The first user input may be routed to an internal agent 106A that specializes in mortgages. The internal agent 106A may produce an output that states the mortgage rate for the user.

In some embodiments, the internal agent 214 to perform operations in accordance with the operations described by FIG. 7. Turning now to FIG. 7, example operations are shown for the processing of the first user input by a selected internal agent 106A-106N.

As shown by operation 702, the apparatus 200 includes means, such as processor 202, memory 204, communications hardware 206, internal agent 214, or the like, for receiving first user input and/or prompts relating to the first user input. In various embodiments, the internal agent 214 (e.g., internal agent 106A-106N, see FIG. 1) may receive the first user input from the routing component 210, via the communications hardware 206. For example, the first user input relating to the mortgage rates available to the user. The first user data may be sent to a mortgage specialized internal agent 214. In some embodiments, the internal agent 214 may receive the unencrypted first user input data. For example, the first user input relating to interest rates of saving accounts may have included no sensitive data and as such the unencrypted first user input data may be sent to the internal agent 214. In other embodiments, the internal agent 214 may receive prompts generated by the logic agent 208 in response to the first user input. For example, the logic agent 208 may have determined a set of tasks and prompts designed to achieve the tasks and provide an accurate response to the first user input. For example, if the first user input relates to the international transfer of funds from USD to GBP. The logic agent 208 may generate a set of ordered prompts, relating to determining the exchange rate, associated fees, calculation of the amount of USD required, and legal information. All the prompts may be sent to a single agent, or a specific prompt may be sent to a specific agent. For example, the prompt relating to fees may be sent to a specialized transfer fee internal agent 214.

As shown by operation 704, the apparatus 200 includes means, such as processor 202, memory 204, communications hardware 206, internal agent 214, or the like, for determining if the internal agent requires more user data to process the first user input. In some embodiments, the internal agent may determine that additional user data may be required for the processing of the user input. For example, the first user input may contain an inquiry about what interest rate the user may get for a personal loan. The internal agent 214 may determine that to respond to this inquiry the internal agent may require the credit score of the user. If the credit score of the user is not in the first user input the process may continue at 706. In an instance where the internal agent does require additional user data to process the first user input the process may continue at operation 710.

As shown by operation 706, the apparatus 200 includes means, such as processor 202, memory 204, communications hardware 206, internal agent 214, or the like, for accessing user database. In some embodiments, the internal agent 214 may determine they need more user data to respond to the first user input. The internal agent 214 may access a user database (e.g., user database 110, see FIG. 1). The user database may contain additional data relating to the user and the user's account, stored in a secure manner. For example, user database 110 may contain the credit score of the user, account information of the user, or the like. The internal agent 214 may use this information for the processing of the first user input.

As shown by operation 708, the apparatus 200 includes means, such as processor 202, memory 204, communications hardware 206, internal agent 214, or the like, for retrieving the additional user data. In various embodiments, the internal agent 214 may retrieve the additional user data required to respond to the first user input, from the user database 110.

As shown by operation 710, the apparatus 200 includes means, such as processor 202, memory 204, communications hardware 206, internal agent 214, or the like, for determining if the agent requires output data from another agent. In various embodiments, the first user input may be represented by a set of prompts that may be sent to a variety of agents (internal agent 106A-106N and/or external agent 108A-108N). In some embodiments, the internal agent 214 may require output data from another agent to generate a response to the first user input. For example, if the first user input related to a request for a loan. The logic agent 208 may split the response into several prompts, the first prompt may relate to the user's current financial situation and a second prompt that relates to the bank's loan policy. The first prompt may be sent to an internal agent 106A that is specialized on user finances. The second prompt may be sent to an internal agent 106N that is specialized on the banks loan policies. The internal agent 106N may require the information regarding the user's finances from internal agent 106A to generate an appropriate response to the first user input. In an instance where the internal agent 214 does require output data from another agent the process may continue at operation 712. In an instance where the internal agent 214 does not require output data from another agent the processing may continue at operation 714.

As shown by operation 712, the apparatus 200 includes means, such as processor 202, memory 204, communications hardware 206, internal agent 214, or the like, for retrieving the output data from the other agent. In various embodiments, the internal agent 214 may retrieve via the communications hardware 206 output data from another agent (e.g., internal agent 106A-106N and/or external agent 108A-108N). For example, the internal agent 106N may retrieve the information relating to the user's finances from the internal agent 106A.

As shown by operation 714, the apparatus 200 includes means, such as processor 202, memory 204, communications hardware 206, internal agent 214, or the like, for continuing the processing of the first user inquiry and produce the first output. In various embodiments, the internal agent 214 may continue processing when the internal agent 214 has received the required data to produce an output in response to the first user input. For example, the internal agent 106N may generate a loan proposal for the user based on the user's financial information and the bank's loan policy.

As shown by operation 716, the apparatus 200 includes means, such as processor 202, memory 204, communications hardware 206, internal agent 214, or the like, for communicating the first output to the logic agent 208. In some embodiments, the internal agent 214 may use the communications hardware 206, to send the first output to the logic agent 208. For example, the internal agent 10A6 may send the loan proposal to the logic agent 208, which may subsequently communicate the information to the user.

FIGS. 3-7 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

In some embodiments, some of the operations described above in connection with FIGS. 3-7 may be modified or further amplified. Furthermore, in some embodiments, additional optional operations may be included. Modifications, amplifications, or additions to the operations above may be performed in any order and in any combination.

### Conclusion

As described above, example embodiments provide methods and apparatuses that enable improved response to user input. Example embodiments thus provide tools that overcome the problems faced by employee-based responses to user input. By avoiding the need of employees to manually search for appropriate and accurate responses to user input, example embodiments thus save time and resources, while also eliminating the possibility of human error that has been unavoidable in the past. Moreover, the embodiments describe herein, by automating the routing and generation of a response to user inputs, the sensitive information that may be required to process such inputs may not be accessed by the employee. Providing an extra lay of security to sensitive user data that may be required to respond to the user input. Additionally, by using LLM and agents the embodiments described herein may provide additional information that may not be feasible for an employee to know, or research during the user input interaction. Additionally, by specifically routing the user input the system may allow for the combination of broad responses from an external agent and the specific required details from an internal agent, while protecting the user's sensitive data. Without having to train the internal agents to the level of the external agent. Reducing the training costs for the internal agents. Finally, by automating functionality that has historically required human analysis, the speed and consistency of the responses generated by example embodiments unlocks many new functions that have historically not been available, such as the ability to generate detailed responses to user inputs and questions in near-real-time and provide the response either to the user directly or to an employee.

As these examples all illustrate, example embodiments contemplated herein provide technical solutions that solve real-world problems faced during the generation to response to user inputs. And while generating responses to user inputs has been an issue for decades, the recently exploding amount of data made available by recently emerging technology today has made this problem significantly more acute, as the demand for in depth responses to user inputs has grown significantly even while the complexity of the questions and required knowledge has itself increased. At the same time, the recently arising ubiquity of large language models has unlocked new avenues to solving this problem that historically were not available, and example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, a first user input;
determining, by a logic agent comprising a first large language model, a first topic of the first user input;
determining, by a sensitivity agent comprising a second large language model, presence of first sensitive data associated with the first user input;
determining, by the sensitivity agent, that the first sensitive data is not required to provide a response to the first user input;
generating, by the sensitivity agent, an encrypted first user input by encrypting the first sensitive data in the first user input;
selecting, by a routing component based on the first topic of the first user input, a first agent from a plurality of agents comprising at least one internal agent and at least one external agent;
sending, by the routing component, the encrypted first user input to the first agent; and
receiving, from the first agent, first output data relating to the encrypted first user input.

2. The method of claim 1, further comprising:
receiving, by the communications hardware, a second user input;
determining, by the logic agent, a second topic of the second user input;
selecting, by the routing component based on the second topic of the second user input, a second agent from the plurality of agents, wherein the second agent is an internal agent;
sending, by the routing component, the second user input to the second agent; and
receiving, from the second agent, second output data.

3. The method of claim 2, wherein the first agent is the internal agent, the method further comprising:
processing, by the internal agent, the encrypted first user input;
determining, by the internal agent, that additional user data is required to respond to the first user input;
accessing, by the internal agent, a user database to retrieve the additional user data; and
generating, by the internal agent, the first output data relating to the encrypted first user input.

4. The method of claim 1, further comprising:
generating, by the logic agent, a set of tasks related to the first user input;
generating, by the logic agent, a set of ordered prompts comprising an order for processing the set of tasks, wherein the set of ordered prompts comprises a first prompt;
sending, by the routing component, the first prompt to the first agent, wherein the first agent generates the first output data based on the first prompt; and
generating, by the logic agent, a structured output in response to the first user input based on the first output data and the order for processing the set of ordered prompts.

5. The method of claim 4, further comprising:
selecting, by the routing component, a second agent for processing a second prompt of the set of ordered prompts;
sending, by the routing component, the second prompt to the second agent, wherein the second agent generates second output data based on the second prompt;
receiving, from the second agent, the second output data; and
generating, by the logic agent, the structured output based on the first output data and the second output data.

6. The method of claim 5, further comprising:
determining, by the second agent, additional information used to respond to the second prompt;
sending, by the first agent, the first output data relating to the first prompt to the second agent; and
generating, by the second agent using the first output data, the second output data relating to the second prompt.

7. The method of claim 4, further comprising:
detecting, by the sensitivity agent, potentially biased language included in the first prompt; and
generating, by the sensitivity agent, encrypted first prompt by encrypting the potentially biased language in the first prompt, wherein the first agent generates the first output data based on the encrypted first prompt.

8. The method of claim 1, further comprising determining that the first agent is an external agent, wherein generating the encrypted first user input is performed in response to determining that the first agent is the external agent.

9. The method of claim 1, wherein the first user input is in a facility operating the logic agent, further comprising:
causing, by the communications hardware, a notification of the first output data to be displayed on a computing device in the facility.

10. The method of claim 1, further comprising sending, by the communications hardware, the first output data to a computing device of a user associated with the first user input.

11. The method of claim 1 further comprising:
receiving, by the communications hardware, a second user input;
determining, by the logic agent, a second topic of the second user input;
determining, by the sensitivity agent, a presence of second sensitive data associated with the second user input;
selecting, by the routing component, based on the second topic of the second user input, an internal agent; and
preventing, by a security component, the internal agent from accessing external data sources based on the presence of second sensitive data associated with the second user input.

12. An apparatus comprising:
communications hardware configured to receive a first user input;
a logic agent configured to determine a topic of the first user input;
a sensitivity agent configured to:
determine a presence of first sensitive data included in the first user input,
determine that the first sensitive data is not required to provide a response to the first user input, and
generate an encrypted first user input by encrypting the first sensitive data in the first user input; and
a routing component configured to:
select a first agent from a plurality of agents comprising at least one of an internal agent and an external agent, based on the topic the first user input,
send the encrypted first user input to the first agent, and
receive first output data relating to the encrypted first user input.

13. The apparatus of claim 12, wherein:
the communications hardware is further configured to receive a second user input;
the logic agent is further configured to determine a second topic of the second user input;
the routing component is further configured to:
select based on the second topic of the second user input, a second agent from the plurality of agents, wherein the second agent is the internal agent, and
send the second user input to the second agent; and
the logic agent further configured to receive, from the second agent, second output data.

14. The apparatus of claim 12, wherein the first agent is the internal agent, the first agent is further configured to:
process the encrypted first user input;
determine that additional user data is required to respond to the first user input;
access a user database to retrieve the additional user data; and
generate the first output data relating to the encrypted first user input.

15. The apparatus of claim 12, wherein:
the logic agent is further configured to:
generate a set of tasks related to the encrypted first user input, and
generate a set of ordered prompts comprising an order for processing the set of tasks, wherein the set of ordered prompts comprises a first prompt;
the routing component further configured to send the first prompt to the first agent, wherein the first agent generates the first output data based on the first prompt; and
the logic agent is further configured to generate a structured output in response to the first user input based on the first output data and the order for processing the set of ordered prompts.

16. The apparatus of claim 15, wherein:
the routing component further configured to:
select a second agent for processing a second prompt of the set of ordered prompts, and
send the second prompt to the second agent, wherein the second agent generates second output data based on the second prompt; and
the logic agent further configured to:
receive, from the second agent, second output data, and
generate the structured output based on the first output data and the second output data.

17. The apparatus of claim 16, wherein:
the second agent is configured to determine additional information used to respond to the second prompt;
the first agent is further configured to send the first output data relating to the first prompt to the second agent; and
the second agent is further configured to generate using the first output data, the second output data relating to the second prompt.

18. The apparatus of claim 15, wherein:
the sensitivity agent is further configured to:
detect potentially biased language included in the first prompt, and
generate an encrypted first prompt by encrypting the potentially biased language in the first prompt; and
the first agent is further configured to generate the first output data based on the encrypted first prompt.

19. The apparatus of claim 12, further comprising a security component, wherein:
the communications hardware is further configured to receive a second user input;
the logic agent is further configured to determine a second topic of the second user input;
the sensitivity agent is further configured to determine a presence of second sensitive data associated with the second user input;
the routing component is further configured to select, based on the second topic of the second user input, the internal agent; and
the security component is configured to prevent the internal agent from accessing external data sources based on the presence of second sensitive data associated with the second user input.

20. A computer program product for routing of user inquiries, the computer program product comprising at least one non-transitory computer-readable storage medium storing software instructions that, when executed, cause at least one processor to:
receive a first user input;
determine a first topic of the first user input;
determine presence of first sensitive data associated with the first user input;
determine that the first sensitive data is not required to provide a response to the first user input;
generate an encrypted first user input by encrypting the first sensitive data in the first user input;
select, based on the first topic of the first user input, a first agent from a plurality of agents comprising at least one internal agent and at least one external agent;
send the encrypted first user input to the first agent; and
receive, from the first agent, first output data relating to the encrypted first user input.
